(19) United States
(12) Patent Application Publication
(10) Pub. No.: US 2024/0089219 A1
(43) Pub. Date: Mar. 14, 2024

(54) PACKET BUFFERING TECHNOLOGIES

(71) Applicant: Intel Corporation, Santa Clara, CA (US)

(72) Inventors: Md Ashiqur RAHMAN, Phoenix, AZ (US); Roberto PENARANDA CEBRIAN, Santa Clara, CA (US); Anil VASUDEVAN, Portland, OR (US); Allister ALEMANIA, North Plains, OR (US); Pedro YEBENES SEGURA, San Jose, CA (US)

(21) Appl. No.: 18/388,780

(22) Filed: Nov. 10, 2023

(51) Int. Cl. H04L 49/20; H04L 47/62; H04L 49/90

(52) U.S. Cl. CPC H04L 49/206; H04L 47/621; H04L 49/9063

(57) ABSTRACT

Examples described herein relate to a switch. In some examples, the switch includes circuitry that is configured to: based on receipt of a packet and a level of a first queue, select among a first memory and a second memory device among multiple second memory devices to store the packet, based on selection of the first memory, store the packet in the first memory, and based on selection of the second memory device among multiple second memory devices, store the packet into the selected second memory device. In some examples, the packet is associated with an ingress port and an egress port, and the selected second memory device is associated with a third port that is different than the ingress port or the egress port associated with the packet.

### BACKGROUND

Core features of a data center network include high throughput, low latency, and network stability. However, even with a fine-tuned congestion control (CC) protocol, packet drops can occur in the network due to switch buffer overflow arising from bursty traffic and/or large in-casts. In-cast can be observed at Top-of-Rack (ToR) switches. Moreover, some CC protocols are based on in-order packet delivery and a receiver can drop out-of-order packets. Such drops can lead to added packet receipt latency from retransmissions.

### BRIEF DESCRIPTION OF THE DRAWINGS

FIG. 1 shows an example system.

FIG. 2 depicts an example system.

FIGS. 3A-3D depict an example of operations.

FIGS. 3E-1 to 3E-3 depict an example of operations.

FIG. 4 depicts an example process.

FIG. 5 depicts an example network interface device.

FIGS. 6A-BB depict example network interface devices.

FIG. 7 depicts an example system.

### DETAILED DESCRIPTION

At least to reduce potential for packet drops and reduce potential for increased latency arising from buffer overflow at a switch or network interface device, such as from bursts of received packets, various examples of a switch or network interface device can utilize supplemental memory to store packets. For example, a last hop switch before a destination receiver (e.g., top of rack (TOR or ToR) switch), can forward or copy received packets to an overflow queue in supplemental memory when a target queue allocated for the received packets is full or at or above a level of packet or byte occupancy. The overflow queue can be allocated to a flow of the received packet and/or other flows, a same or different ingress port than that associated with an ingress port of the target queue, and/or a same or different egress port than that associated with an egress port of the target queue. Supplemental memory can include one or more of: on-chip memory in the switch, internal auxiliary memory in the switch, pooled memory connected via a device interface or network interface, device interface connected memory, host memory, and/or memory one or more network interface device hops away from the switch. For example, if a host memory is utilized as supplemental memory, then memory of the host connected to the switch can be utilized as supplemental memory.

In some cases, packet buffering into supplemental memory can introduce latency to packet delivery at a receiver. The latency can arise from time to copy packet header and/or payload data through a device interface or other interface to the supplemental memory and time to egress the packet from the supplemental memory from an egress port of the switch. The switch can cause the packet to be dropped and re-transmitted by a sender, based on a time to re-transmit the dropped packet being less than or equal to a latency associated with storage of the packet into the selected supplemental memory and egress of the packet by the switch. In some cases, even if a level of occupancy of the target queue is less than full or even empty, the switch can cause storage of subsequent received packets, of a flow associated with the packet stored into the overflow queue, into the overflow queue. The switch can cause egress of a packet from the target queue based on a configured wait time and the wait time can be based on a predicted burst duration.

An endpoint receiver can utilize a reorder buffer to store and reorder received packets and wait for a flush period before providing data of in order packets to a packet processing protocol (e.g., Transmission Control Protocol (TCP) protocols and other protocols). Packet ordering can be based at least on packet sequence number (e.g., TCP packet sequence number) or other values.

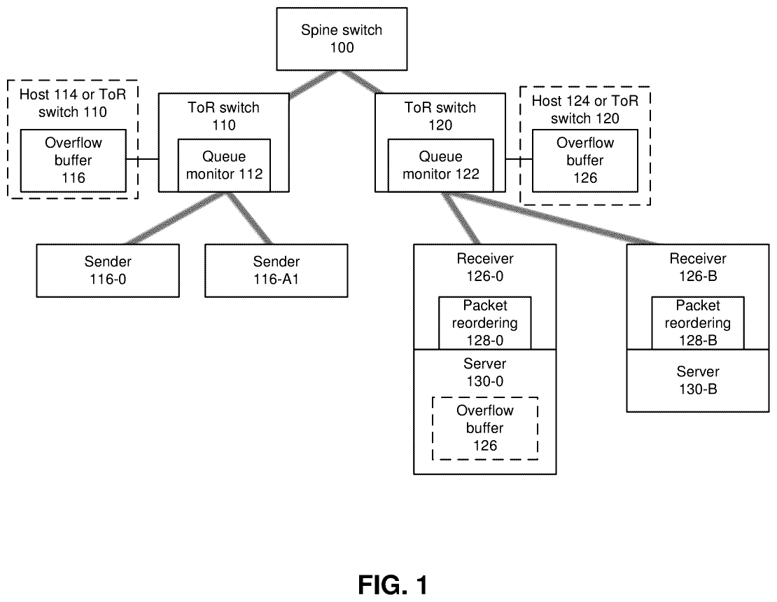

FIG. 1 shows an example system. One or more of sender network interface devices 116-0 to 116-A, where A is an integer, can send packets to one or more of receiver network interface devices 126-0 to 126-B, where B is an integer, via ToR switch 110, spine switch 100, and ToR switch 120 (e.g., last hop switch). In some examples, ToR switch 120 can utilize queue monitor circuitry 122 to monitor queue utilization of one or more queues associated with egress ports. When utilization of a queue exceeds a dynamically defined threshold, queue monitor circuitry 122 can determine whether divert packet traffic to overflow buffer 126 in supplemental memory or memory of ToR switch 120, or drop the packet traffic. For example, supplemental memory can be part of a host system 124. In some examples, if a destination is receiver 126-B, memory of server 130-0 can be used as supplemental memory.

Overflow buffer 126 can include a mix packets of one or different flows and be associated with one or more ingress ports or different egress ports of ToR switch 120. After buffering of one or more packets for a configured amount of time, ToR switch 120 can cause packet traffic to be routed from overflow buffer 126 to the egress port of ToR switch 120 for transmission to one or more of receivers 126-0 to 126-B. By utilizing overflow buffer 126, packet drops at ToR switch 110 can be reduced and overall flow completion time (FCT) can be reduced. While examples are described with respect to ToR switch 120, such examples can apply to operations of ToR switch 110, such as queue monitor 112 and overflow buffer 116, for packets sent to one or more of senders 116-0 to 116-B.

Diversion of packets to overflow buffer 126 can introduce latency of packet traversal to a receiver network interface device. ToR switch 120 may copy or divert received packets to overflow buffer 126 prior to forwarding based on: (a) a baseline latency (e.g., latency in an unloaded fabric) between a sender and ToR switch 120 and/or (b) when latency from packet diversion is less than that of latency introduced by packet re-transmission. For example, latency of packet re-transmission can be based on a number of network interface device hops traversed from sender to ToR switch 120, where such hop traversal count can be recorded in a header of the packet. When the baseline latency level (with or without packet retransmission) between a sender and ToR switch 120 is more than a level, diverting packets to overflow buffer 126 may lead to latency being less than the baseline latency level and can reduce latency of packet traversal from sender to ToR switch 120. When the latency level from packet diversion to overflow buffer 126 and re-ordering at a receiver is more than that of latency introduced by packet re-transmission (e.g., baseline latency), dropping the packet and causing packet re-transmission may lead to reduced latency of packet receipt.

If overflow buffer 126 is used by packets of other flows, such as where supplemental memory is connected to a host sending and receiving packets of flows, the supplemental memory could become congested. Consequently, queue monitor 122 can load balance among supplemental memory devices when choosing which supplemental memory to use or whether to use supplemental memory. Examples of manners to select a supplemental memory to use include but are not limited to selecting the supplemental memory with the smallest utilization. In some examples, the selected supplemental memory can be utilized for an integer N successive packets of a same or different flow as the packet buffered in overflow buffer 126 to attempt to provide for in-order packets deliver to a receiver. In the case of supplemental memories that also store packets for independent traffic (e.g., packets from host 124 or server 130-0), utilization of the supplemental memory by packets for independent traffic and diverted packets from ToR switch 120 can be considered to determine a level of utilization of the supplemental memory.

Reflection or diversion delay can be based on an amount of time a packet is stored in overflow buffer 126. Overflow buffer 126 can buffer packets that would otherwise be dropped due to overflow, such as during bursts of traffic, which can be short-lived in duration. Accordingly, in some cases, packets diverted to overflow buffer 126 may not be forwarded to a next hop (e.g., one or more of receiver 126-0 and 126-1) until the burst has subsided. If ToR switch 120 can observe egress utilization to a next hop, ToR switch 120 (e.g., queue monitor 122) can implement a dynamic wait time such that ToR switch 120 can cause retrieval and forwarding of packets buffered in overflow buffer 126 after the wait time. The wait time can be based on historic measurements of burst duration (or after a predefined wait time).

In some examples, a determination of whether to put a packet in overflow buffer 126 or drop the packet can be based on priority of a packet's flow, per-packet priority, service level agreement (SLA), service level objective (SLO), priority of packet stream, or other factors. For example, higher priority packets can be given priority, over lower priority packets, to be stored in overflow buffer 126 and lower priority packets can be dropped. In some examples, a determination of when ToR switch 120 is to egress packets from overflow buffer 126 can be based on priority of a packet's flow, per-packet priority, SLA, SLO, priority of packet stream, or other factors. For example, higher priority packets can be given priority to egressed from overflow buffer 126 over lower priority packets.

With diverted packets and reflection (diversion) delay, a receiver may receive out-of-order packets. Packet reordering 128-0 to 128-B can reorder packets based on sequence number provided in a packet header and provide in-order packets to a protocol stack for protocol processing (e.g., operating system (OS) processing of packet headers) in a host (e.g., one or more of server 130-0 to 130-B) after a flush duration. The flush duration can be greater than or equal to latency introduced by buffering packets in overflow buffer 126 to increase the probability that, upon a reorder buffer flush, the packet protocol layer receives in-order packets. However, this waiting adds to latency, hence, and the flush duration can be reduced to reduce latency.

Flush duration and reflection delay can be low so to not add too much latency as it can lead to delayed congestion notification back to the sender, and introduce delayed reaction and slowdown, hence potentially increased packet drops. Small message flows, which can utilize a low amount of bandwidth and can be sensitive to latency can bypass supplemental buffering, and be queued in buffer 126, to not significantly degrade application performance. Such flows can be identified as sub-maximum transmission unit (MTU) packets from header information.

Protocol processing performed by one or more of server 130-0 to 130-B can apply media access control (MAC) layer processing on the packet using MAC context information including using driver data structures, driver statistic structures, and so forth. The MAC context information can be prefetched into cache of a core that performs MAC layer processing. Protocol processing can apply Internet Protocol (IP) layer processing of an IP header and decide whether packet is to be pushed to TCP layer processing or forwarded to another device. The IP layer can extract information from a packet to inspect IPv4 context (e.g., action, forward, up host). IP context information prefetched into a cache can be used to decide on the next stage for the received packet. TCP layer processing can include inspecting a TCP header, determining TCP compliance to check if sequence number is expected. TCP context information can be loaded into a cache of a core that performs TCP layer processing to process the packet. TCP context information can include one or more of: sequence number, congestion window, outstanding packets, out of order queue information, and so forth. For example, TCP context information can be loaded into a cache of a core that performs TCP layer processing.

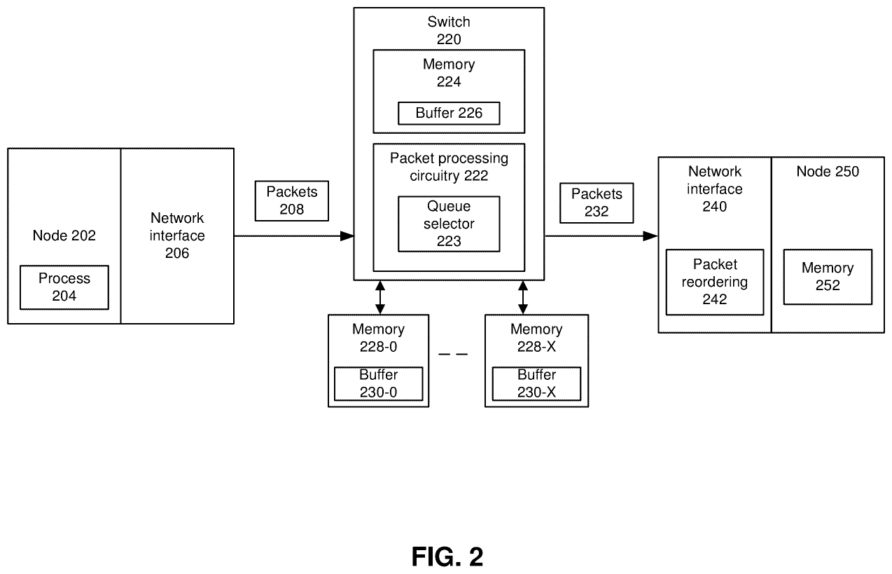

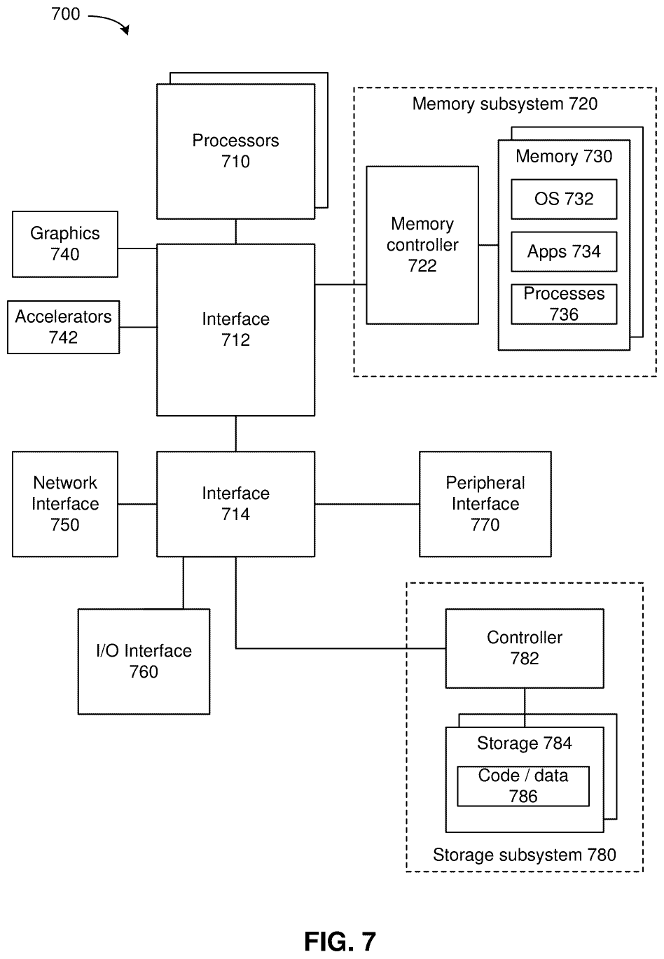

FIG. 2 depicts an example system. For example, network interface 206 can transmit packets 208, at the request of process 204 executed by circuitry of node 202, to network interface 240 via switch 220 and potentially one or more other switches or routers. At least one example of node 202 is described with respect to FIG. 7. Switch 220 can be positioned as a ToR switch and positioned as a last hop before endpoint receiver network interface device 240 or other switch.

Switch 220 can utilize packet processing circuitry 222 to parse and process packet headers based on match-action operations. In some examples, packet processing circuitry 222 can perform operations of queue selector 223. Queue selector 223 can select a buffer to store packets received from network interface 206 from among buffer 226 allocated in memory 224 or one or more of buffer 230-0 to buffer 230-X allocated in respective memory devices 228-0 to 228-X, where X is an integer. For example, selection of buffer 226 or one or more of buffer 230-0 and/or buffer 230-X can be based on various criteria described herein. In some examples, one or more of buffer 230-0 to buffer 230-X can be allocated in memory 224 (e.g., on-chip with packet processing circuitry 222) and/or in one or more of memory 228-0 to 228-X.

In some examples, packet processing circuitry 222 can be included in a system on chip (SoC). In some examples, packet processing circuitry 222 can be implemented as a packet processing pipeline that performs match-action operations based on a configuration. For example, a determination of which memory or buffer to store a packet can be based on match-action operations. In some examples, memory 224 can be connected to the SoC of switch 220, where the SoC is connected to one or more ingress ports and one or more egress ports. In some examples, memory devices 228-0 to 228-X can be connected to switch SoC via at least one device interface.

To divert a packet of packets 208 to one or more of buffer 230-0 to buffer 230-X, packet processing circuitry 222 can select another egress port for the packet instead of an assigned egress port. In some examples, the another egress port can provide communication to a selected supplemental memory device or a device interface (e.g., Compute Express Link (CXL) or Peripheral Component Interconnect Express (PCIe)) to provide a communication with an assigned supplemental memory device. If the packet is not diverted to a selected supplemental memory, packet processing circuitry 222 can forward the packet to the assigned egress port for transmission to network interface 240.

In some examples, packet processing circuitry 222 can select a supplemental memory that has the lowest queue utilization for load-balanced traffic diversion according to the process below.

| | |
|---|---|
| 1: | function PacketDiversion(packet, percentage) |
| 2: | if packet.GetNumHops > 1 and |
| 3: | packet.size ≥ MTU and |
| 4: | !CanFitEgressMemory(packet, percentage) and |
| 5: | !packet.isDiverted then |
| 6: | portₘᵢₙ ← FindLeastOccupiedPort( ) |
| 7: | if portₘᵢₙ ≠ packet.port_{egress} then |
| 8: | packet.port_{egress} ← portₘᵢₙ |
| 9: | packet.isDiverted ← true |
| 10: | else if packet.isDiverted then |
| 11: | packet.isDiverted ← false |

Line 2 determines that the sender-receiver pair is not within same ToR. Line 3 checks if the current packet size is equal or greater than one maximum transmission unit (MTU). This check is to bypass supplemental memory in case a packet is small, e.g., a flow with only one sub-MTU packet. Line 4 checks if the current packet cannot fit in memory based on diversion threshold percentage (P_{divert}), and line 5 checks if the packet has already been diverted to avoid diverting the same packet twice. In line 6, if four conditions in lines 2, 3, 4, and 5 hold, then find a portₘᵢₙ other than the originally destined egress port of the ToR with least queue occupancy. In line 7, if portₘᵢₙ is other than the actual receiver port packet. port_{egress}, egress, the egress port for the packet can be set to be port min in line 8 and the packet marked as diverted in line 9. Thus, the packet can be diverted to the selected supplemental memory or the packet is forwarded to the intended receiver. If any of the conditions on lines 2, 3, 4, or 5 do not hold and the packet is already marked as diverted in line 10, the state of the packet is reset to not diverted in line 11.

At the supplemental memory, buffered packets can be routed through a one or more first in first out (FIFO) queues (e.g., one or more of buffer 230-0 to 230-X). If the supplemental memory stores packets for flows originated by a host server, switch 220 can perform arbitration to determine whether to egress packets originated by a host server (not shown) or packets that were buffered due to overflow. Arbitration can favor egress of packets from the host server over diverted packets, in some examples.

Switch 220 can transmit packets 232 to network interface 240 based on packets stored in buffer 226 or one or more of buffer 230-0 and/or buffer 230-X. In some examples, packet processing circuitry 222 can re-order packets stored in buffer 226 and one or more of buffer 230-0 to buffer 230-X, based on packet sequence number specified in header fields of the packets, and transmit packets of a same flow to network interface 240 in sequence number order. In some examples, packet processing circuitry 222 can cause transmission of packets stored in buffer 226 and one or more of buffer 230-0 to buffer 230-X, irrespective of packet ordering according to sequence numbers, to network interface 240. For example, packet processing circuitry 222 can prioritize transmission of packets stored in buffers 230-0 to 230-X, over packets in buffer 226, to reduce latency of packet delivery, to network interface 240, from buffers 230-0 to 230-X.

In some examples, network interface 240 can perform packet reordering 242 to reorder received packets 232 from switch 230 prior to copying received packets for processing by node 250 after a flush duration. For example, node 250 can process packets utilizing a driver or operating system. The flush duration of the receiver's reorder buffer can be greater than or equal to latency introduced by buffering packets in supplemental memory to increase the probability that, upon a reorder buffer flush, the packet protocol layer receives in-order packets.

A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer.

A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

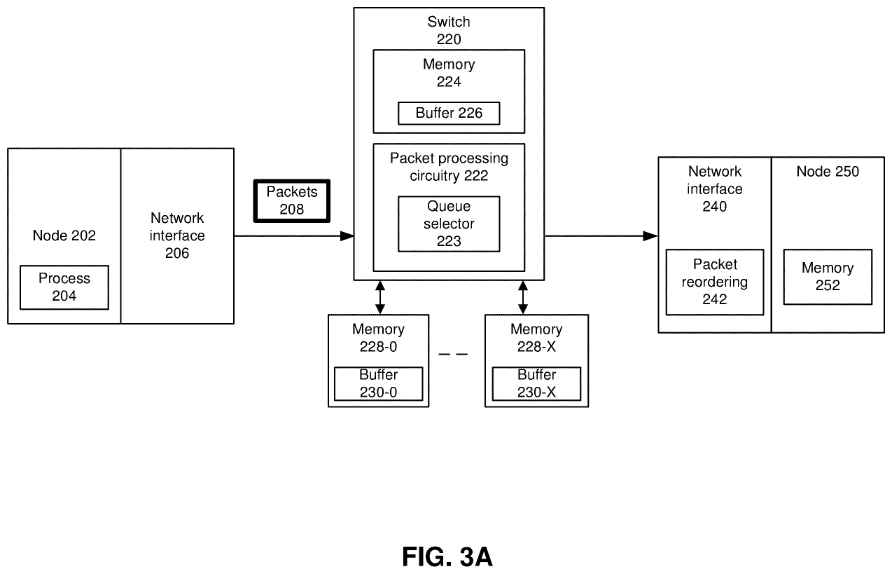

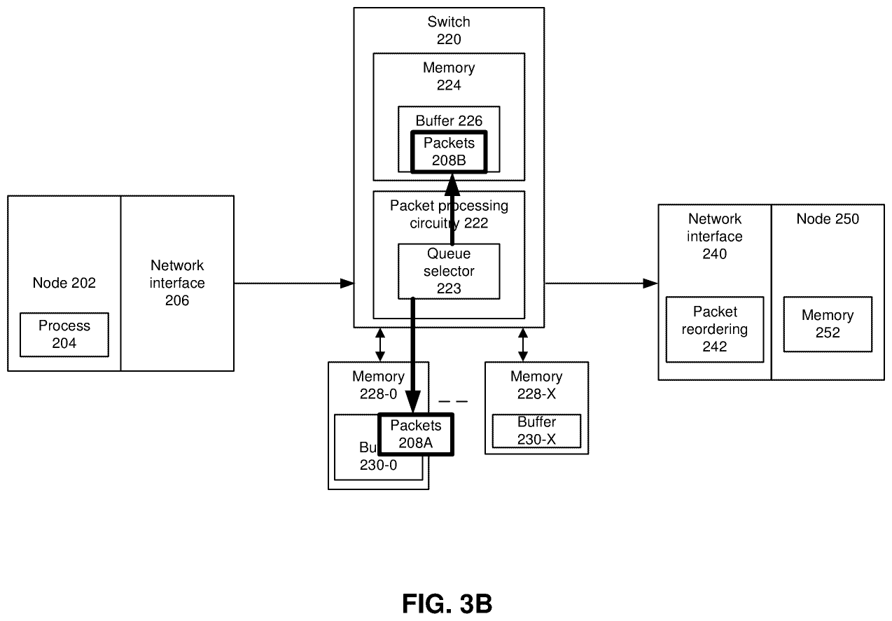

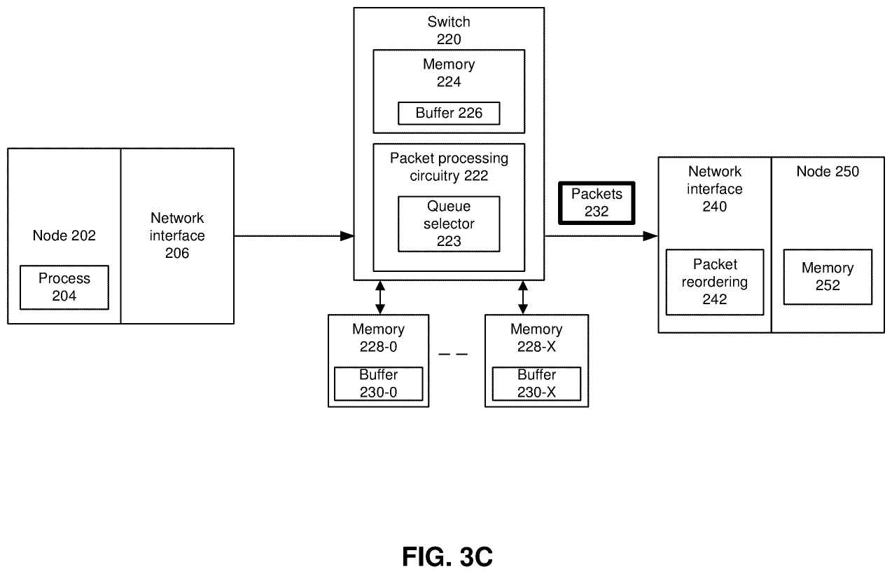

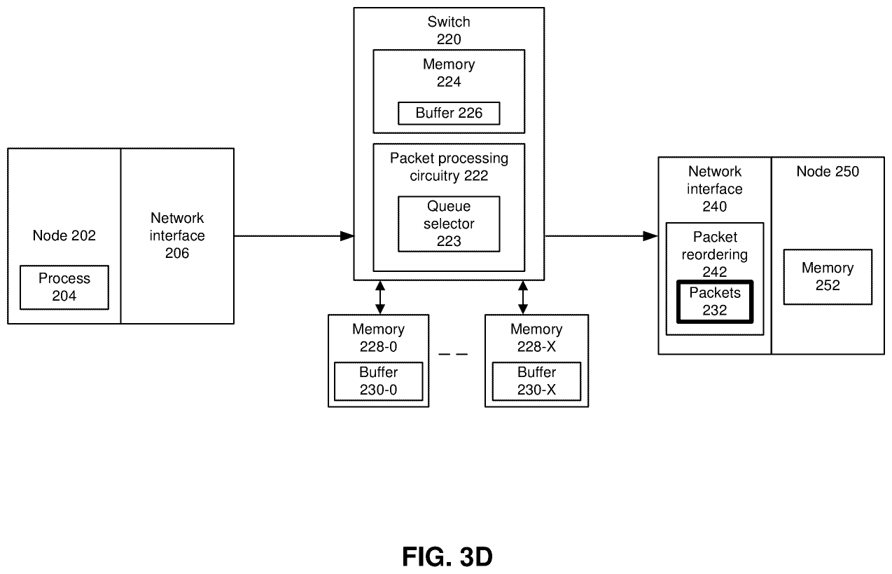

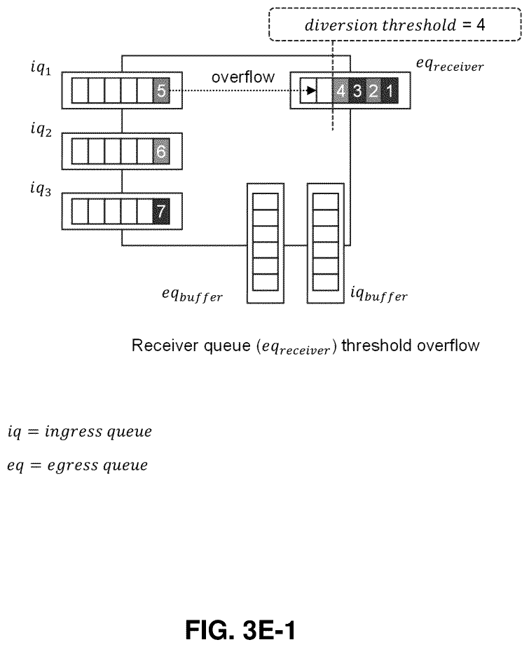

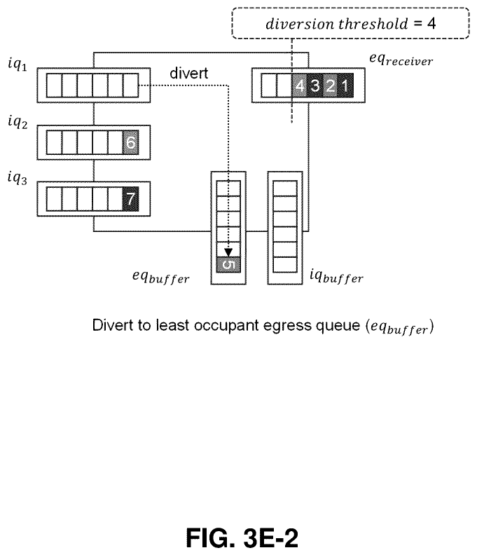

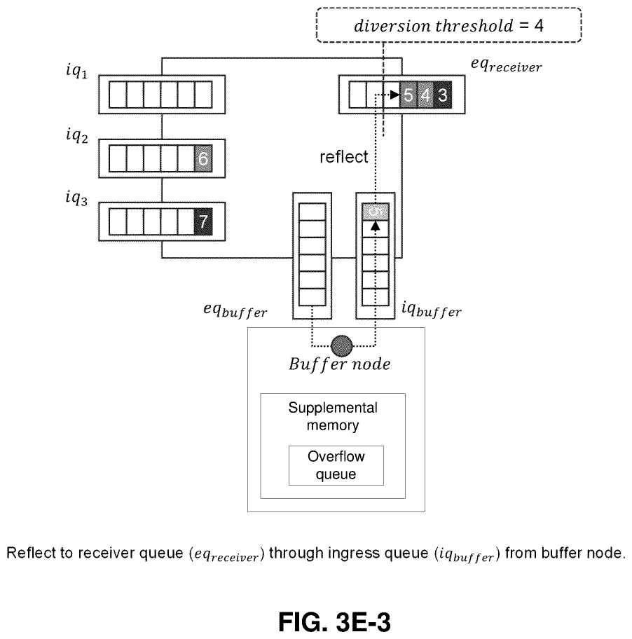

FIGS. 3A-3D depict a sequence of operations. FIG. 3A depicts an example of transmission of packets 208 by network interface 206 to network interface 240 via switch 220. FIG. 3B depicts an example of storage of one or more packets of packets 208 in buffer 226 for forwarding to an egress port. In addition, queue selector 223 can divert one or more of packets 208 into one or more of buffers 230-0 to 230-X based on a level of buffer 226 as well as factors such as whether another packet of a same flow was stored in one or more of buffers 230-0 to 230-X. FIG. 3C depicts an example of forwarding of packets from buffer 226 and/or one or more of buffers 230-0 to 230-X to network interface 240. FIG. 3D depicts an example of packet reordering of received packets 232.

FIGS. 3E-1 to 3E-3 depict an example of operations. In some examples, one or more of buffers iq₁, iq₂, iq₃, eq_{buffer}, iq_{buffer}, and/or eq_{receiver} can be allocated in memory of a switch and/or a supplemental memory. Buffers iq₁ to iq₃ can be associated with one or more ingress ports and buffer eq_{receiver} can be associated with one or more egress ports. FIG. 3E-1 shows an example of an egress queue packet occupancy level exceeding an overflow level and the packet 5 is diverted to an overflow egress queue (eq_{buffer}), as shown in FIG. 3E-2. Arbitration for egress of packets from queues iq₁-iq₃ can be based on priority of flow, round robin, weighted round robin, or other factors. In some examples, egress buffer eq_{buffer} can be associated with a port or device interface connected to a buffer node (e.g., supplemental memory in a host or another network interface device). Buffer node can include a host with a supplemental memory that is connected to a switch through a device interface or network port. Examples of buffer node include a host with a supplemental memory, a network interface device with a supplemental memory, a memory pool, or a device interface-connected memory device.

FIG. 3E-3 depicts an example of packet egress from the overflow egress queue. Egress of packets from overflow queue in supplemental memory can be based on one or more of: prioritize packets originated for transmission by the host server associated with the supplemental memory, first in first out (FIFO), prioritize diverted packet traffic, egress based on packet priority, or others. Note that while a single overflow queue is shown, multiple overflow queues can be used, where two or more of the overflow queues are associated with different priority levels or at least one overflow queue is allocated to diverted traffic and at least one other overflow queue is associated with traffic originated by the host server.

In some examples, the diverted packet can be allocated in egress buffer eq_{buffer}, and to ingress buffer iq_{buffer}, prior to egress from buffer eq_{receiver}. In some examples, egress buffer eq_{buffer}, and/or ingress buffer iq_{buffer} can be allocated in memory of a switch and/or a supplemental memory. In some examples, buffers eq_{buffer} and iq_{buffer} can be associated with one or more network interface ports and/or device interfaces connected to the buffer node. In some examples, instead of associating diverted packet 5 with an ingress queue (iq_{buffer}), the diverted packet 5 in eq_{buffer} can be allocated to eq_{receiver} directly instead of being placed into iq_{buffer} prior to egress.

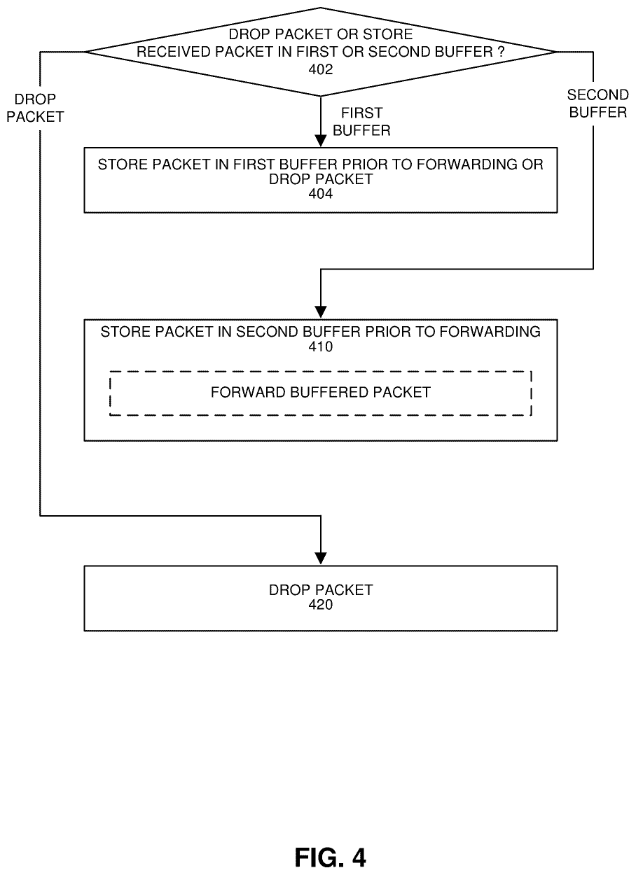

FIG. 4 depicts an example process. The process can be performed by a switch. At 402, based on receipt of a packet and in accordance with a configuration, the received packet can be stored in a first buffer or a second buffer or dropped. For example, the first buffer can be allocated in a memory of the switch and the second buffer can be allocated in memory of the switch and/or a supplemental memory coupled to the switch, such as in a memory pool, memory device, or host system one or more hops from the switch. For example, a determination to store the packet in the first buffer can be based on the configuration that specifies a level of the first buffer being at or below a configured threshold level. For example, a determination to store the packet in the second buffer can be based on one or more of: a prior packet of a same flow was stored in the second buffer or a level of the first buffer being above the configured threshold level. For example, a determination to drop the packet can be based on the configuration that specifies to drop the packet instead of storing the packet in the second buffer, such as if sender-to-switch latency (e.g., time duration or number of hops) of packet re-transmission is less than or equal to latency introduced by storing the packet in second buffer and re-ordering packets.

Based on storage of the packet in the first buffer, at 404, the packet can be stored in the first buffer. Based on scheduled transmission of the packet, the packet can be transmitted through a selected egress port to a receiver.

Based on storage of the packet in the second buffer, at 410, the packet can be stored in the second buffer. The packet can be forwarded from the second buffer through an egress port of the switch to a receiver based on expiration of a timer specified in the configuration. For example, the timer can be based on predicted duration of a burst of received packets at the switch. In some examples, the second buffer can be allocated in a supplemental memory connected through a device interface or other connection to the switch. The switch can load balance among available supplemental memory devices to select a supplemental memory in which to store the packet.

In some examples, based on a level of the first buffer being at or above the level, the packet can be dropped at 420. In some examples, the switch can send a negative acknowledgement to the sender of the packet to cause re-transmission of the packet or the switch can send a pause request to reduce transmission rate of packets of a flow of the dropped packet.

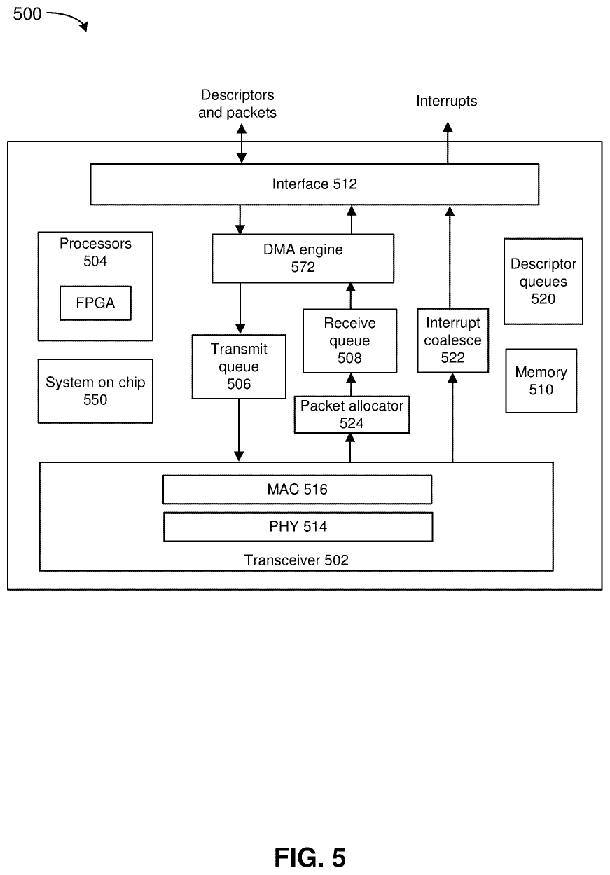

FIG. 5 depicts an example network interface device or packet processing device. In some examples, circuitry of network interface device can buffer packets in a supplemental memory, as described herein. In some examples, packet processing device 500 can be implemented as a network interface controller, network interface card, a host fabric interface (HFI), or host bus adapter (HBA), and such examples can be interchangeable. Packet processing device 500 can be coupled to one or more servers using a bus, PCIe, CXL, or Double Data Rate (DDR). Packet processing device 500 may be embodied as part of a system-on-a-chip (SoC) that includes one or more processors, or included on a multichip package that also contains one or more processors.

Some examples of packet processing device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and host interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values. Processors 504 and/or system on chip (SoC) 550 can include one or more of a:
processor, core, graphics processing unit (GPU), field programmable gate array (FPGA), application specific integrated circuit (ASIC), or other programmable hardware device that allow programming of network interface 500. For example, a “smart network interface” can provide packet processing capabilities in the network interface using processors 504.

Processors 504 and/or system on chip 550 can include one or more packet processing pipelines that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504 and/or system on chip 550, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

As described herein, processors 504, system on chip 550, or other circuitry can be configured to allocate packets for storage in a buffer in memory of network interface 750 or another device or drop packets and determine when to egress packets.

Packet allocator 524 can provide distribution of received packets for processing by multiple CPUs or cores using timeslot allocation described herein or RSS. When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 can provide the coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Host interface 512 can provide an interface with host device (not depicted). For example, host interface 512 can be compatible with PCI, PCI Express, PCI-x, Serial ATA, and/or USB compatible interface (although other interconnection standards may be used).

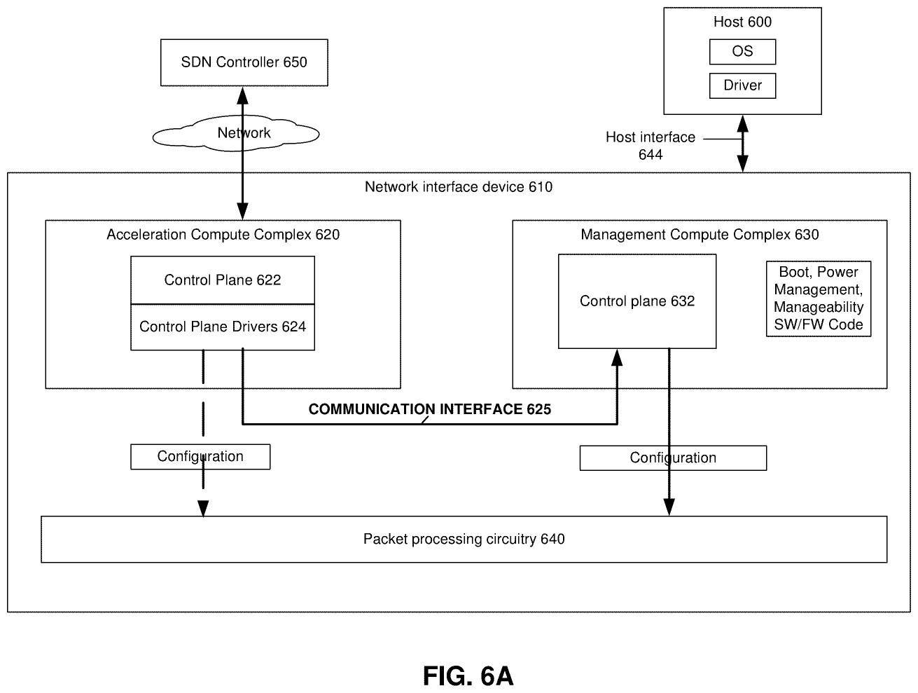

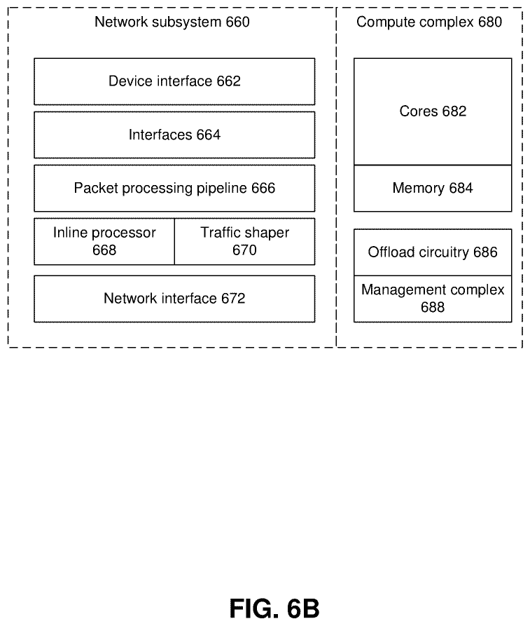

FIG. 6A depicts an example system. Host 600 can include processors, memory devices, device interfaces, as well as other circuitry such as described with respect to one or more of FIGS. 2, 5, and/or 6B. Processors of host 600 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 610 to utilize one or more control planes to communicate with software defined networking (SDN) controller 650 via a network to configure operation of the one or more control planes. Host 600 can be coupled to network interface device 610 via a host or device interface 644.

Network interface device 610 can include multiple compute complexes, such as an Acceleration Compute Complex (ACC) 620 and Management Compute Complex (MCC) 630, as well as packet processing circuitry 640 and network interface technologies for communication with other devices via a network. ACC 620 can be implemented as one or more of: a microprocessor, processor, accelerator, field programmable gate array (FPGA), application specific integrated circuit (ASIC) or circuitry described at least with respect to FIG. 6B and/or 7. Similarly, MCC 630 can be implemented as one or more of: a microprocessor, processor, accelerator, field programmable gate array (FPGA), application specific integrated circuit (ASIC) or circuitry described at least with respect to FIGS. 2, 5, and/or 6B. In some examples, ACC 620 and MCC 630 can be implemented as separate cores in a CPU, different cores in different CPUs, different processors in a same integrated circuit, different processors in different integrated circuit. In some examples, circuitry and software of network interface device 610 can be configured to determine whether to divert a packet to a buffer in supplemental memory or drop packets and when to egress packets, as described herein.

Network interface device 610 can be implemented as one or more of: a microprocessor, processor, accelerator, field programmable gate array (FPGA), application specific integrated circuit (ASIC) or circuitry described at least with respect to FIGS. 2, 5, and/or 6B. Packet processing pipeline circuitry 640 can process packets as directed or configured by one or more control planes executed by multiple compute complexes. For example, processing pipeline circuitry 640 can be configured to determine whether to store packets in a buffer in memory of network interface 750 or another device or drop packets and when to egress packets, as described herein. In some examples, ACC 620 and MCC 630 can execute respective control planes 622 and 632.

SDN controller 650 can upgrade or reconfigure software executing on ACC 620 (e.g., control plane 622 and/or control plane 632) through contents of packets received through packet processing device 610. In some examples, ACC 620 can execute control plane operating system (OS) (e.g., Linux) and/or a control plane application 622 (e.g., user space or kernel modules) used by SDN controller 650 to configure operation of packet processing pipeline 640. Control plane application 622 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 650 can communicate with ACC 620 using a remote procedure call (RPC) such as Google remote procedure call (gRPC) or other service and ACC 620 can convert the request to target specific protocol buffer (protobuf) request to MCC 630. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 650 can provide packet processing rules for performance by ACC 620. For example, ACC 620 can program table rules (e.g., header field match and corresponding action) applied by packet processing pipeline circuitry 640 based on change in policy and changes in VMs, containers, microservices, applications, or other processes. ACC 620 can be configured to provide network policy as flow cache rules into a table to configure operation of packet processing pipeline 640. For example, the ACC-executed control plane application 622 can configure rule tables applied by packet processing pipeline circuitry 640 with rules to define a traffic destination based on packet type and content. ACC 620 can program table rules (e.g., match-action) into memory accessible to packet processing pipeline circuitry 640 based on change in policy and changes in VMs.

For example, ACC 620 can execute a virtual switch such as vSwitch or Open vSwitch (OVS), Stratum, or Vector Packet Processing (VPP) that provides communications between virtual machines executed by host 600 or with other devices connected to a network. For example, ACC 620 can configure packet processing pipeline circuitry 640 as to which VM is to receive traffic and what kind of traffic a VM can transmit. For example, packet processing pipeline circuitry 640 can execute a virtual switch such as vSwitch or Open vSwitch that provides communications between virtual machines executed by host 600 and packet processing device 610.

MCC 630 can execute a host management control plane, global resource manager, and perform hardware registers configuration. Control plane 632 executed by MCC 630 can perform provisioning and configuration of packet processing circuitry 640. For example, a VM executing on host 600 can utilize packet processing device 610 to receive or transmit packet traffic. MCC 630 can execute boot, power, management, and manageability software (SW) or firmware (FW) code to boot and initialize the packet processing device 610, manage the device power consumption, provide connectivity to a management controller (e.g., Baseboard Management Controller (BMC)), and other operations.

One or both control planes of ACC 620 and MCC 630 can define traffic routing table content and network topology applied by packet processing circuitry 640 to select a path of a packet in a network to a next hop or to a destination network-connected device. For example, a VM executing on host 600 can utilize packet processing device 610 to receive or transmit packet traffic.

ACC 620 can execute control plane drivers to communicate with MCC 630. At least to provide a configuration and provisioning interface between control planes 622 and 632, communication interface 625 can provide control-plane-to-control plane communications. Control plane 632 can perform a gatekeeper operation for configuration of shared resources. For example, via communication interface 625, ACC control plane 622 can communicate with control plane 632 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 625 can be utilized by a negotiation protocol and configuration protocol running between ACC control plane 622 and MCC control plane 632. Communication interface 625 can include a general purpose mailbox for different operations performed by packet processing circuitry 640. Examples of operations of packet processing circuitry 640 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 625 can include one or more mailboxes accessible as registers or memory addresses. For communications from control plane 622 to control plane 632, communications can be written to the one or more mailboxes by control plane drivers 624. For communications from control plane 632 to control plane 622, communications can be written to the one or more mailboxes. Communications written to mailboxes can include descriptors which include message opcode, message error, message parameters, and other information. Communications written to mailboxes can include defined format messages that convey data.

Communication interface 625 can provide communications based on writes or reads to particular memory addresses (e.g., dynamic random access memory (DRAM)), registers, other mailbox that is written-to and read-from to pass commands and data. To provide for secure communications between control planes 622 and 632, registers and memory addresses (and memory address translations) for communications can be available only to be written to or read from by control planes 622 and 632 or cloud service provider (CSP) software executing on ACC 620 and device vendor software, embedded software, or firmware executing on MCC 630. Communication interface 625 can support communications between multiple different compute complexes such as from host 600 to MCC 630, host 600 to ACC 620, MCC 630 to ACC 620, baseboard management controller (BMC) to MCC 630, BMC to ACC 620, or BMC to host 600.

Packet processing circuitry 640 can be implemented using one or more of: application specific integrated circuit (ASIC), field programmable gate array (FPGA), processors executing software, or other circuitry. Control plane 622 and/or 632 can configure packet processing pipeline circuitry 640 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 620 or MCC 630. In some examples, a P4 program can be compiled and provided to MCC 630 to configure packet processing circuitry 640. The following is a JSON configuration file that can be transmitted from ACC 620 to MCC 630 to get capabilities of packet processing circuitry 640 and/or other circuitry in packet processing device 610. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 6B depicts an example network interface device system. Various examples of packet processing device or network interface device 610 can utilize components of the system of FIGS. 2, 5, and/or 6A. In some examples, network interface device 610 can be configured to determine whether to store packets in a buffer in memory 684 or in an overflow buffer in a different attached memory device or drop packets and when to egress packets, as described herein. In some examples, packet processing device or network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Network subsystem 660 can be communicatively coupled to compute complex 680. Device interface 662 can provide an interface to communicate with a host. Various examples of device interface 662 can utilize protocols based on Peripheral Component Interconnect Express (PCIe), Compute Express Link (CXL), or others as well as virtual device interface such as virtual device interfaces.

Interfaces 664 can initiate and terminate at least offloaded remote direct memory access (RDMA) operations, Non-volatile memory express (NVMe) reads or writes operations, and LAN operations. Packet processing pipeline 666 can perform packet processing (e.g., packet header and/or packet payload) based on a configuration and support quality of service (QoS) and telemetry reporting. Inline processor 668 can perform offloaded encryption or decryption of packet communications (e.g., Internet Protocol Security (IPSec) or others). Traffic shaper 670 can schedule transmission of communications. Network interface 672 can provide an interface at least to an Ethernet network by media access control (MAC) and serializer/de-serializer (Serdes) operations.

Cores 682 can be configured to perform infrastructure operations such as storage initiator, Transport Layer Security (TLS) proxy, virtual switch (e.g., vSwitch), or other operations. Memory 684 can store applications and data to be performed or processed. Offload circuitry 686 can perform at least cryptographic and compression operations for host or use by compute complex 680. Offload circuitry 686 can include one or more graphics processing units (GPUs) that can access memory 684. Management complex 688 can perform secure boot, life cycle management and management of network subsystem 660 and/or compute complex 680.

FIG. 7 depicts a system. In some examples, circuitry of system 700 can determine whether to store packets in a buffer in network interface device 750 or a buffer in supplemental memory or drop packets and when to egress packets, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 732, a system administrator, and/or orchestrator can configure network interface 750 to determine whether to store packets in a buffer in memory of network interface 750 or another device or drop packets and when to egress packets, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 4, 5, 6A, 6B, and/or 7.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes an apparatus that includes: a switch system on chip (SoC) comprising circuitry to: based on receipt of a packet and a level of a first queue, select among a first memory and a second memory device among multiple second memory devices to store the packet, based on selection of the first memory, store the packet in the first memory, and based on selection of the second memory device among multiple second memory devices, store the packet into the selected second memory device, wherein the packet is associated with an ingress port and an egress port, and the selected second memory device is associated with a third port that is different than the ingress port or the egress port associated with the packet.

Example 2 includes one or more examples, wherein: the circuitry is to cause the packet to be dropped based re-transmission of the packet and a latency associated with storage of the packet into the selected second memory device.

Example 3 includes one or more examples, wherein: after storage of the packet into the selected second memory device, the circuitry is to cause storage of subsequent received packets of a flow associated with the packet into the selected second memory device.

Example 4 includes one or more examples, wherein: the circuitry is to cause egress of the packet from the selected second memory device based on a configured wait time.

Example 5 includes one or more examples, wherein the selected second memory device is to store packets of multiple different packet flows.

Example 6 includes one or more examples, wherein the circuitry comprises a packet processing pipeline.

Example 7 includes one or more examples, wherein the switch SoC is positioned in a last hop switch before an endpoint receiver of the packet.

Example 8 includes one or more examples, and includes at least one ingress port coupled to the switch SoC; at least one egress port coupled to the switch SoC; and one or more device interfaces coupled to the switch SoC.

Example 9 includes one or more examples, and includes a method that includes: in a switch: based on receipt of a packet and a level of a first queue, selecting among an first memory and a second memory device among multiple second memory devices to store the packet, based on selection of the first memory, storing the packet into the first queue in the first memory, and based on selection of the second memory device among multiple second memory devices, storing the packet into a second queue of the selected second memory device, wherein the packet is associated with an ingress port and an egress port, and the second queue is associated with a third port that is different than the ingress port or the egress port associated with the packet.

Example 10 includes one or more examples, and includes dropping the packet based on a time to re-transmit the packet and a latency associated with storage of the packet into the selected second memory device.

Example 11 includes one or more examples, and includes after storage of the packet into the second queue, storing subsequent received packets of a flow associated with the packet into the second queue.

Example 12 includes one or more examples, and includes egressing the packet from the second queue based on a configured wait time.

Example 13 includes one or more examples, wherein the second queue stores packets of multiple different packet flows.

Example 14 includes one or more examples, wherein the switch is positioned in a last hop switch before an endpoint receiver of the packet.

Example 15 includes one or more examples, and includes at least one non-transitory computer-readable medium comprising instructions stored thereon, that if executed by one or more circuitry, cause the one or more circuitry in a switch to: based on receipt of a packet and a level of a first queue, select among an first memory and a second memory device among multiple second memory devices to store the packet, based on selection of the first memory, store the packet into the first queue in the first memory, and based on selection of the second memory device among multiple second memory devices, store the packet into a second queue of the selected second memory device, wherein the packet is associated with an ingress port and an egress port, and the second queue is associated with a third port that is different than the ingress port or the egress port associated with the packet.

Example 16 includes one or more examples, and includes instructions stored thereon, that if executed by one or more circuitry, cause the one or more circuitry in the switch to: drop the packet based on a time to re-transmit the packet and a latency associated with storage of the packet into the selected second memory device.

Example 17 includes one or more examples, and includes instructions stored thereon, that if executed by one or more circuitry, cause the one or more circuitry in the switch to: after storage of the packet into the second queue, store subsequent received packets of a flow associated with the packet into the second queue.

Example 18 includes one or more examples, and includes instructions stored thereon, that if executed by one or more circuitry, cause the one or more circuitry in the switch to: egress the packet from the second queue based on a configured wait time.

Example 19 includes one or more examples, wherein the second queue is to store packets of multiple different packet flows.

Example 20 includes one or more examples, and includes instructions stored thereon, that if executed by one or more circuitry, cause the one or more circuitry in the switch to: select the second memory device to store the packet based on priority of the packet, priority of a flow of the packet, or service level agreement (SLA).

1. An apparatus comprising:
a switch system on chip (SoC) comprising circuitry to:
based on receipt of a packet and a level of a first queue, select among a first memory and a second memory device among multiple second memory devices to store the packet,
based on selection of the first memory, store the packet in the first memory, and
based on selection of the second memory device among multiple second memory devices, store the packet into the selected second memory device, wherein the packet is associated with an ingress port and an egress port, and the selected second memory device is associated with a third port that is different than the ingress port or the egress port associated with the packet.

2. The apparatus of claim 1, wherein:
the circuitry is to cause the packet to be dropped based re-transmission of the packet and a latency associated with storage of the packet into the selected second memory device.

3. The apparatus of claim 1, wherein:
after storage of the packet into the selected second memory device, the circuitry is to cause storage of subsequent received packets of a flow associated with the packet into the selected second memory device.

4. The apparatus of claim 1, wherein:
the circuitry is to cause egress of the packet from the selected second memory device based on a configured wait time.

5. The apparatus of claim 1, wherein the selected second memory device is to store packets of multiple different packet flows.

6. The apparatus of claim 1, wherein the circuitry comprises a packet processing pipeline.

7. The apparatus of claim 1, wherein the switch SoC is positioned in a last hop switch before an endpoint receiver of the packet.

8. The apparatus of claim 1, comprising:
at least one ingress port coupled to the switch SoC;
at least one egress port coupled to the switch SoC; and
one or more device interfaces coupled to the switch SoC.

9. A method comprising:
in a switch:
based on receipt of a packet and a level of a first queue, selecting among an first memory and a second memory device among multiple second memory devices to store the packet,
based on selection of the first memory, storing the packet into the first queue in the first memory, and
based on selection of the second memory device among multiple second memory devices, storing the packet into a second queue of the selected second memory device, wherein the packet is associated with an ingress port and an egress port, and the second queue is associated with a third port that is different than the ingress port or the egress port associated with the packet.

10. The method of claim 9, comprising:
dropping the packet based on a time to re-transmit the packet and a latency associated with storage of the packet into the selected second memory device.

11. The method of claim 9, comprising:
after storage of the packet into the second queue, storing subsequent received packets of a flow associated with the packet into the second queue.

12. The method of claim 9, comprising:
egressing the packet from the second queue based on a configured wait time.

13. The method of claim 9, wherein the second queue stores packets of multiple different packet flows.

14. The method of claim 9, wherein the switch is positioned in a last hop switch before an endpoint receiver of the packet.

15. At least one non-transitory computer-readable medium comprising instructions stored thereon, that if executed by one or more circuitry, cause the one or more circuitry in a switch to:
based on receipt of a packet and a level of a first queue, select among an first memory and a second memory device among multiple second memory devices to store the packet,
based on selection of the first memory, store the packet into the first queue in the first memory, and
based on selection of the second memory device among multiple second memory devices, store the packet into a second queue of the selected second memory device, wherein the packet is associated with an ingress port and an egress port, and the second queue is associated with a third port that is different than the ingress port or the egress port associated with the packet.

16. The computer-readable medium of claim 15, comprising instructions stored thereon, that if executed by one or more circuitry, cause the one or more circuitry in the switch to:
drop the packet based on a time to re-transmit the packet and a latency associated with storage of the packet into the selected second memory device.

17. The computer-readable medium of claim 15, comprising instructions stored thereon, that if executed by one or more circuitry, cause the one or more circuitry in the switch to:
after storage of the packet into the second queue, store subsequent received packets of a flow associated with the packet into the second queue.

18. The computer-readable medium of claim 15, comprising instructions stored thereon, that if executed by one or more circuitry, cause the one or more circuitry in the switch to:
egress the packet from the second queue based on a configured wait time.

19. The computer-readable medium of claim 15, wherein the second queue is to store packets of multiple different packet flows.

20. The computer-readable medium of claim 15, comprising instructions stored thereon, that if executed by one or more circuitry, cause the one or more circuitry in the switch to:
select the second memory device to store the packet based on priority of the packet, priority of a flow of the packet, or service level agreement (SLA).
